(19) United States
(12) Patent Application Publication
(10) Pub. No.: US 2021/0107823 A1
(43) Pub. Date: Apr. 15, 2021

(54) FLAT GLASS HAVING AT LEAST ONE PREDETERMINED BREAKING POINT

(71) Applicant: SCHOTT AG, Mainz (DE)

(72) Inventors: Thomas KUCKELKORN, Jena (DE); Patrick BARTHOLOME, Jena (DE); Dietmar KNOLL, Jena (DE); Oliver KIRCHNER, Jena (DE)

(73) Assignee: SCHOTT AG, Mainz (DE)

(21) Appl. No.: 17/129,805

(22) Filed: Dec. 21, 2020

Related U.S. Application Data
(63) Continuation of application No. PCT/EP2019/064655, filed on Jun. 5, 2019.

(30) Foreign Application Priority Data
Jun. 21, 2018 (DE) 10 2018 114 973.5

(51) Int. Cl. C03B 33/02; C03B 33/033; C03C 17/00

(52) U.S. Cl. CPC C03B 33/0222; C03C 17/002; C03B 33/033

(57) ABSTRACT

A flat glass is provided that includes a first side face, an opposite, second side face, and at least one edge face. The flat glass has a linear predetermined breaking location on the first or second side face. The flat glass also has two mutually separated points, where at least one of the two mutually separated points lies on the linear predetermined breaking location. The two mutually separated points are each configured as a point of attack for a force for breaking the flat glass. The two mutually separated points have breaking forces required to break the flat glass that differ from one another in magnitude and/or direction.

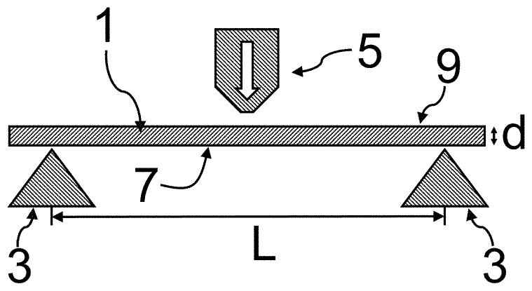

### CROSS REFERENCE TO RELATED APPLICATIONS

This application is a continuation of International Application PCT/EP2019/064655 filed on Jun. 5, 2019, which claims the benefit under 35 USC 119 of German Application DE 10 2018 114 973.5 filed on Jun. 21, 2018, the entire contents of both of which are incorporated herein by reference.

### BACKGROUND

### 1. Field of the Invention

The invention relates to a flat glass having at least one linear predetermined breaking location, at least two mutually separated points being provided, which both respectively lie on a linear predetermined breaking location so that the forces required to break the flat glass, which respectively act on these points, differ from one another in their magnitude and/or their direction. The invention furthermore relates to the use of such a flat glass as a substrate for applications in the field of medical diagnosis.

### 2. Description of Related Art

Flat glass is produced in industrial production methods such as floating, rolling or casting. A common feature of these methods is that they can be performed commensurately more economically when the dimensions of the flat glass being produced are larger. There is therefore a trend toward larger glass formats in flat glass manufacturing. For many typical applications of flat glass, for example cover glasses for displays or solar cells, slides for microscopy or glass panes for microfluidic applications, it is necessary to divide the large glass formats into smaller formats in the course of production.

It may in this case be advantageous not to carry out the division of the flat glass until after further processing, since many further processing operations can also be performed more economically on the basis of a larger glass format because of scaling effects. This applies in particular for most printing and coating methods, and very particularly for vacuum coating methods. In particular, it may also be necessary to divide the flat glass into a plurality of intermediate formats in the course of production, before it is divided into the final delivery format. For example, it may be possible to carry out generally required method steps on large formats, and to carry out customer- or project-specific method steps on smaller or more specific formats. One such generally required method step is, for example, cleaning before the application of a coating. A specific method step may, for example, be the application of a customer-specific coating or marking.

In most methods for the division of flat glass, a predetermined breaking location in the form of a trench-like indentation is initially produced on one of the side faces. The glass is subsequently separated along the predetermined breaking location by action of force. The action of force may, for example, take place using a machine or manually.

There are a range of different methods for producing the indentation. For example, the indentation may be produced by means of mechanical scoring, water-jet erosion or laser erosion. Mechanical scoring is inexpensive, but is substantially restricted to straight cuts. Although water-jet erosion allows the production of freeform geometries, it is relatively slow and expensive, and also has a limited edge quality. Material erosion by means of a laser likewise allows freeform geometries and is relatively slow and expensive. Laser erosion furthermore causes local heating of the glass in the region of the predetermined breaking location. It is therefore not suitable for glasses with delicate coatings.

A further method for producing a predetermined breaking location in flat glass is the method of laser filamentation. In this case, a trench-like indentation is preferably not produced, but instead the microstructure of the glass is locally weakened. To this end, a separating line, for example in the form of a perforation, is introduced into the glass using an ultrashort-pulse laser.

As described for instance by WO 2012/006736 A2, filaments may be produced in a transparent substrate using a pulsed focused laser beam, a path formed by a plurality of filaments making it possible to separate the substrate. A filament is in this case produced by a high-energy short laser pulse which is absorbed by nonlinear optical processes in the substrate, so that plasma formation is induced. This plasma leads to a modification of the microstructure of the substrate.

DE 10 2012 110 971 A1 also describes a method of preparing for the separation of transparent workpieces, in which sequenced filament structures extending transversely through the workpiece are produced along a predetermined breaking location by ultrashort laser pulses. After a filament path, particularly in the form of a predamage line or perforation line, has been introduced into the glass by means of laser filamentation, the glass may be separated in a further step. During the separation, however, particularly in the case of complex geometries, defects may occur, for instance by the crack not following the previously introduced separating line and splitting or terminating. In this method as well, the separating lines are therefore adjusted in such a way that they have a maximally homogeneous breaking force along their length.

The breaking force is in this case to be understood as the force which is required in order to break or separate the flat glass at a predetermined breaking location.

All these methods are thus optimized to adjust maximally constant breaking forces for dividing the flat glass, in order to produce an edge quality that is as high as possible. The achievable range of variation of such breaking forces is limited by the usual production variations. Even with relatively large production variations, the lowest magnitude of a breaking force is usually at least 95% of the highest breaking force.

This, however, has the disadvantage that division along the predetermined breaking location always takes place regardless of where the force acts. Unintentional division may thus take place if the breaking force acts on the flat glass at an incorrect location.

### SUMMARY

It is an object of the invention to provide a flat glass for which the risk of unintentional separation of a predetermined breaking location is reduced.

The invention therefore relates to a flat glass having a first side face, an opposite second side face, at least one edge face, at least one linear predetermined breaking location on the first or second side face, and at least two mutually separated points, which respectively lie on a linear predetermined breaking location and are therefore each configured as a point of attack for a force for breaking the flat glass, at least one of the two points lying on the first linear predetermined breaking location, characterized in that the forces required to break the flat glass, which respectively act on these points, differ from one another in their magnitude and/or their direction.

According to the invention, in the usual way, a flat glass is intended to mean a glass body in the form of a pane or plate. A flat glass may thus, for example, be in the form of a rectangular plate with a width, length and thickness, the thickness being less than the width and less than the length. A flat glass may likewise, for example, be in the form of a circular pane with a diameter and a thickness, the thickness in turn being less than the diameter. The flat glass may assume any desired geometries in the basic shape, in particular circular, elliptical, triangular, rectangular or hexagonal or a freeform shape.

The flat glass has a first and a second side face, the spacing of which corresponds to the thickness of the glass body. The flat glass preferably has a thickness of from 0.7 mm to 10 mm, particularly preferably from 1 to 4 mm. These side faces are arranged substantially parallel to one another. Depending on the use of the flat glass, the side faces of the flat glass may for example form a front and a rear side or a lower and an upper side. Furthermore, depending on the geometry, the flat glass also has at least one edge face. The height of the edge face in this case corresponds to the thickness of the glass body. An edge face is thus a connecting face between the two side faces. In the case of a circular geometry of the side faces, the flat glass only has one circumferential edge face. In the case of a triangular geometry, the flat glass has three edge faces. In the case of a rectangular geometry, it has four edge faces. In the case of a hexagonal geometry, it has six edge faces.

The flat glass is not restricted to a particular material class of glasses. It may for example contain or consist of soda-lime glass, borosilicate glass, aluminosilicate glass, LAS glass or other silicate glasses. In particular, it may consist of one of the following commercially available glasses: SCHOTT AF32®, SCHOTT D263® and SCHOTT BOROFLOAT® 33.

The flat glass has at least one linear predetermined breaking location on the first or second side face. The linear predetermined breaking location is arranged in such a way that the flat glass is divided into two flat glasses when breaking along the predetermined breaking location. To this end, the line may for example extend from one edge of the flat glass to another edge, form a contour closed on itself, extend from one linear predetermined breaking location to a further linear predetermined breaking location or from a linear predetermined breaking location to an edge. A contour closed on itself may, in particular, be a circle or a rectangle.

A linear predetermined breaking location is in this case intended to mean a linearly extended region in which the glass is locally structurally weakened. The force required to break the glass is thus lower in this region than in its immediately adjacent vicinity. Such a region is linear if its transverse span is small in relation to the longitudinal extent. The ratio of transverse span to longitudinal extent may for example be less than 0.1, less than 0.01 or even less than 0.001. Linear furthermore means that the predetermined breaking location does not have any branching. Two linear predetermined breaking locations may, however, intersect. Furthermore, a linear predetermined breaking location may be rectilinear or curved.

The flat glass furthermore comprises at least two mutually separated points, which respectively lie on such a linear predetermined breaking location and are therefore each configured as a point of attack for a force for breaking the flat glass. The term point is in this case to be understood in the geometrical sense. The two points preferably have a spacing of at least 5 mm. The force for breaking the flat glass is merely to be understood as that component of the force acting on the respective point which is directed perpendicularly to the surface of the glass. The force for breaking the glass corresponds in its magnitude to the destruction threshold of the glass in the region of the predetermined breaking location. At least one of the two points lies on the first linear predetermined breaking location.

Furthermore, the flat glass is characterized in that the forces required to break the flat glass, which respectively act on these two points, differ from one another in their magnitude and/or their direction.

A flat glass configured in such a way thus has different breaking forces for separation at least at two points. In this way, unintentional separation of a predetermined breaking location starting from an unintended point may be effectively prevented.

If the forces are different in their magnitude, it is advantageous for the magnitudes of the breaking forces to differ by at least 10%, preferably at least 20% and particularly preferably at least 30%, in relation to the greater of the two magnitudes, for a spacing of the points of at least 5 mm. The smaller magnitude should thus be at most 90%, preferably at most 80%, particularly preferably at most 70% of the larger magnitude. The greater the difference between the magnitude of the breaking forces is, the more effectively unintentional separation of a predetermined breaking location can be prevented.

In a first preferred embodiment, both points lie on the first predetermined breaking location. According to the invention, the forces required for breaking must then differ in their magnitude. Furthermore, the forces required for breaking then have the same direction. This embodiment thus corresponds to a variant in which forces of different strength must act along a single predetermined breaking location in order to break the glass.

This is advantageous particularly for flat glasses with inhomogeneous properties. A flat glass may, for example, comprise a coating that has a gradient in its thickness, this gradient extending parallel to such a predetermined breaking location. The predetermined breaking location may in turn extend from one edge of the glass to an opposite edge. It may then be advantageous for the breaking force on in the vicinity of one edge of the flat glass to be higher than on another, so that the profile of the crack when breaking extends along the gradient of the coating.

It is particularly advantageous for the magnitude of the force required to break the glass to decrease continuously along the predetermined breaking location. Surprisingly, it has been found that the resulting separating line then extends very accurately along the predetermined breaking location. A better edge quality is thus achieved. It is particularly advantageous for the magnitude to decrease by at least 10% per cm, preferably by at least 20% per cm and more particularly preferably by at least 30% per cm.

With such a flat glass, for example, it is possible to fix the flat glass in the region of the predetermined breaking location with a high breaking force on a strong mechanical holder for a further processing operation, for example coating, without the predetermined breaking location being separated. Despite this, the predetermined breaking location may then be separated after this process step with a lower breaking force at the previously unfixed location. In this case, unintentional separation by the mechanical holder is effectively prevented and, at the same time, easy separability with a high edge quality is ensured.

In a second preferred embodiment, the flat glass comprises at least one second linear predetermined breaking location, so that one of the two points lies on the first predetermined breaking location and the other point lies on the second predetermined breaking location. If both these predetermined breaking locations lie on the first side face, the breaking forces at the respective points must differ in their magnitude. The direction of the breaking forces is then the same.

In this embodiment, the breaking forces may be substantially constant along each of the predetermined breaking locations. Both predetermined breaking locations then have a constant breaking force per se, the breaking force for separating the first predetermined breaking location differing from one another from the breaking force for separating the second predetermined breaking location as described above.

As an alternative, the two predetermined breaking locations may also respectively have a nonconstant breaking force, in particular a continuously decreasing or increasing breaking force. It is then for example advantageous if, for neighboring predetermined breaking locations, the breaking force increases along one breaking location and decreases along the neighboring breaking location. This arrangement leads to further protection against unintentional separation of neighboring predetermined breaking locations.

This embodiment thus corresponds to an arrangement in which the flat glass comprises at least one second linear predetermined breaking location and at least two further mutually separated points, the first two points lying on the first predetermined breaking location and the two further points both lying on the second linear predetermined breaking location and therefore respectively being configured as a point of attack for a force for breaking the flat glass, the forces required to break the flat glass, which respectively act on these points, differing from one another in their magnitude.

In a further preferred embodiment, the first linear predetermined breaking location is arranged on the first side face and the second linear predetermined breaking location is arranged on the opposite second side face of the flat glass. In this embodiment, the breaking forces in each case differ in their direction. The breaking forces must then respectively act in opposite directions in order to separate the respective predetermined breaking location. They may additionally differ in their magnitude as well. The two predetermined breaking locations may also have constant or varying breaking forces in this embodiment.

These embodiments having at least two predetermined breaking locations with different breaking forces are particularly advantageous if, in a stepwise process, the flat glass are separated into different intermediate formats, and are processed further, in a plurality of intermediate steps. By means of the direction and magnitude, it is possible to adjust accurately which predetermined breaking location is intended to be separated in which method step, without the other regions being unintentionally separated. In this case, it is particularly advantageous if the predetermined breaking locations to be separated first have a lower breaking force than those to be separated later. Inadvertent separation of an unintended region is thus effectively prevented. This is advantageous in particular for methods which provide manual separation of the predetermined breaking locations.

Furthermore, in this embodiment it is advantageous in particular for two predetermined breaking locations to intersect. In the case of the predetermined breaking locations known from the prior art with a constant breaking force, it may occur at points of intersection that the crack propagating in the direction of the intersection during the separation jumps over onto the intersecting predetermined breaking location and unintentionally separates it. For predetermined breaking locations that intersect, particularly high protection against unintentional separation of a predetermined breaking location is thus likewise provided by the embodiment according to the invention. This applies in particular when the intersecting predetermined breaking locations make an angle of between 90° and 180°.

In a further preferred embodiment, the flat glass comprises at least one coating on at least one side face, which contains at least one of the following materials: epoxysilane, aminosilane, aldehydesilane, a polymer having a reactive N-hydroxysuccinimide terminal group, streptavidin, indium tin oxide (ITO) or chromium.

In a further preferred embodiment, the linear predetermined breaking location is formed by a locally reduced thickness of the flat glass, in particular a trench-like indentation in a side face, or by a locally restricted weakening of the microstructure of the glass, in particular a crack along the predetermined breaking location on a side face of the flat glass with a defined penetration depth, or a microstructure locally modified by filamentation by means of an ultrashort-pulse laser.

A reduced thickness, in particular a trench-like indentation, may be produced by means of mechanical material erosion, for example scoring. As an alternative, material may be eroded by means of laser ablation. These methods are well known to the person skilled in the art. The magnitude of the breaking force in this case depends on the thickness of the material. Thus, if in such an embodiment the breaking force differs in its magnitude at the two points, the thickness of the flat glass also differs at these points.

Furthermore, a predetermined breaking location may also be formed as locally restricted weakening of the microstructure of the glass. One form of such weakening is a crack along the predetermined breaking location on a side face of the flat glass. Such a crack may be deliberately introduced into the glass by first locally heating the glass very rapidly by means of a laser and then cooling very rapidly by active cooling. Such a crack may be formed by this high alternating thermal stress along the irradiated region. The depth of the crack may be controlled by the heating and cooling rates. The heating rate may be adjusted by the wavelength of the laser radiation and the optical power density of the laser beam. The cooling rate may for example be adjusted by the selection of the cooling fluid, its temperature and flow rate.

A further possibility for locally restricted weakening of the microstructure is to locally modify the microstructure by filamentation by means of an ultrashort-pulse laser. The method of laser filamentation is known from the prior art. During laser filamentation, a sequence of approximately cylindrical material modifications is introduced into the flat glass into the glass by means of ultrashort-pulse lasers, i.e. lasers with a pulse length of approximately less than 100 μs. The modifications may be produced by nonlinear interactions between the glass and the laser, for example by laser-induced plasma formation. Since thermal processes do not play a significant part in it, this method is very rapid and spatially very highly localized. The spatially restricted cylindrical modifications may for example have a diameter of less than 500 μm, less than 100 μm or even less than 20 μm. The modifications may be arranged on a side face of the flat glass. As an alternative, the modifications may extend over the entire thickness of the flat glass and therefore be arranged on both side faces. As an alternative, the modifications may extend only in the volume of the flat glass, without being arranged on one of the side faces.

In one preferred embodiment, the modifications extend at least partially through the thickness of the flat glass, these modifications being formed on at least one of the side faces of the flat glass, preferably on the opposite side from the point of attack of the force for breaking the glass, or in the volume of the flat glass without contact with one of the side faces of the flat glass.

The extent, or the degree, of the modification and the volume of the modification, and therefore the resulting breaking force, may be adjusted by means of the parameters of the laser. These include for example the power, the pulse repetition rate, the forward speed of the lateral relative movement between the laser beam and the flat glass, the burst rate, the number of pulses per modification, or the diameter of the laser beam in the region of the modification. In particular, the spacing of the individual modifications may be influenced by the forward speed and the pulse repetition rate.

With the method of laser filamentation, predetermined breaking locations with a different breaking force may be produced particularly simply. For example, it is sufficient to vary the relative forward speed between the laser and the flat glass with a constant pulse repetition rate in order to produce predetermined breaking locations with a different breaking force. The breaking force is in this case reduced by increasing the forward speed, since the spacing between the individual modifications is reduced. Likewise, the forward speed may be varied during the production of an individual predetermined breaking location so that the spacing between individual local modifications on the predetermined breaking location is different. In this way, predetermined breaking locations with a variable, in particular a continuously decreasing, breaking force may be produced in a simple way. In particular, it is thereby possible to make the spacing of the modifications increase or decrease continuously, in particular linearly, along the predetermined breaking location. A linear variation of the spacing may surprisingly be adjusted particularly simply by a uniform acceleration of the relative movement between the laser and the flat glass. For this purpose, it is unimportant whether the laser beam is moved over the stationary flat glass or whether the flat glass is moved past the stationary laser beam.

The maximum forward speed is, however, in each case to be selected so that with the given pulse repetition rate the individual modifications do not spatially overlap. The maximum value of the forward speed is thus given by the pulse repetition rate and the diameter of the material modifications.

In a further preferred embodiment, the flat glass comprises at least one linear predetermined breaking location which is formed by a modification of the microstructure of the glass, this predetermined breaking location being formed by a sequence of spatially restricted, nonoverlapping modifications of the microstructure.

The spacing and/or the volume of the modifications in the region of the first point may in this case be less than or greater than the spacing and/or the volume of the modifications in the region of the second point. The modifications in the region of the first point may, in addition or as an alternative, be modified more strongly or less strongly than the modifications in the region of the second point.

During the laser filamentation, it is furthermore deliberately possible to direct individual laser pulses at arbitrary positions on the flat glass and therefore produce material modifications of the microstructure at arbitrary positions. In this way, particularly precise breaking force profiles and freeform shapes of predetermined breaking locations may thus be generated.

In such an embodiment, the breaking force may be adjusted deliberately and independently at each point of a predetermined breaking location. This embodiment therefore allows very accurate adjustment of the breaking force. Such a flat glass therefore has the best protection against unintentional separation of a predetermined breaking location.

The other aforementioned methods, i.e. scoring, laser ablation or crack formation, are suitable for producing predetermined breaking locations with a constant breaking force. In this way, in particular, it is also possible to produce two predetermined breaking locations on the same side face of a flat glass with a different breaking force. Economically, however, it is not possible to reproducibly produce individual predetermined breaking locations with a variable breaking force in the sense of the invention with these methods. This is possible only by means of the described laser filamentation.

In the case of scoring, it is furthermore not possible, or at least not economically possible, to produce predetermined breaking locations on both side faces of the flat glass in thin glasses, for example with a thickness of less than 2 mm. The force required for the mechanical scoring of the second predetermined breaking location would lead to separation of the predetermined breaking location on the opposite side face.

Flat glasses according to the invention are suitable in particular for use in multistage further processing operations, which require different glass formats after each process step.

A further aspect of the invention is therefore the use of a flat glass according to the invention as a substrate for applications in the field of medical diagnosis. This includes, in particular, DNA microarrays or protein microarrays.

In medical diagnosis, there are many methods in which biological material are applied onto coated or uncoated substrates made of flat glass. In particular, the materials mentioned above may be used as coatings in this case. Since the least possible biological material should always be used for ethical reasons and/or cost reasons, it is generally sufficient for these substrates to have small dimensions for the use. These may for example be 5*5*1 mm³. Particularly in the case of coated substrates or substrates that contain microfluidic components, however, production on such small formats is not economical. Transport without damage and handling are also less difficult with larger formats than with small formats.

It is therefore particularly advantageous for such substrates to be produced in large formats and then manually divided by the user. Because of the manual division and the relatively high unit costs, it is in this case particularly important that predetermined breaking locations cannot be separated unintentionally. The use of flat glasses according to the invention for such substrates is therefore particularly advantageous.

Such substrates may be in the form, for example, of a slide, plate, wafer or chip with and without microfluidic components or coatings.

The magnitude of the breaking force at a point on the predetermined breaking location may be determined with a 3-point bending test. This measurement method will be explained in more detail below.

### BRIEF DESCRIPTION OF THE DRAWINGS

The sold FIGURE shows a schematic representation, not true to scale, of a measurement layout for determining the breaking force in cross section.

### DETAILED DESCRIPTION

For the measurement of the breaking force, a flat glass 1 having square side faces with an edge length b and a thickness d is used. Conventionally, the edge length should be 30 mm and the thickness should be 1 mm. The edge length b of a measurement specimen must, however, in this case be at least 20 times the thickness of the flat glass: b≥20*d. Measurements on other, in particular rectangular, geometries are however likewise possible.

The flat glass 1 lies supported along a narrow contact line on two supports 3. The supports 3 in this case have a spacing L which is adjusted to 15 times the thickness of the glass: L=15*d. With a thickness of d=1 mm, the spacing is thus L=15 mm.

The breaking force under tensile stress is always measured for glass. This means that the side face on which the predetermined breaking location to be measured is arranged must be arranged on the lower side 7 for the measurement. Since with rigid bodies the point of attack of a force can always be displaced along the line of action, the action of a compressive force on the opposite side 9 from the predetermined breaking location and the action of a tensile force on the side of the predetermined breaking location 7 are equivalent. The direction and magnitude of these forces are then identical, and the forces are merely displaced along the line of action perpendicularly to the surface of the flat glass 1.

During the measurement, a force is applied to the flat glass 1 from the upper side 9 by means of a pin 5, this force being increased continuously during the measurement until the flat glass 1 breaks. The magnitude of the force at which the flat glass breaks corresponds to the breaking force. The pin 5 in this case acts only pointwise on the predetermined breaking location. In particular, the contact face of the pin, which comes into contact with the flat glass 1, is flat and circular with a diameter of 0.5 mm. The pin 5 may, for example, be made of stainless steel. The arrow represented in the FIGURE on the pin 5 indicates the movement direction of the pin 5 and therefore the direction of the force action, or the line of action.

For the present invention, it is not important to determine the absolute breaking force. It is sufficient merely to determine the relative breaking force differences at different points of a predetermined breaking location, or at points of different predetermined breaking locations. The dimensions mentioned above may therefore be varied in a wide range. They must, however, be kept constant for the measurement values to be compared. For example, instead of a flat circular contact face, a spherical pin 5 with a suitably chosen diameter, for example 2 mm, may also be selected for the pin.

For measurement of the breaking force at different positions of an individual predetermined breaking location, it is necessary to produce a multiplicity of identical specimens and to carry out the measurement at each position to be measured on the predetermined breaking location on a plurality of specimens. By means of the values determined in this way, it is then possible to average in order to obtain reliable information about the breaking force distribution along a predetermined breaking location produced in a defined way.

The way in which a flat glass according to the invention may be produced by laser filamentation will be described by way of example below.

One suitable laser source according to the present invention is a neodymium-doped yttrium aluminum garnet laser with a wavelength of 1064 nanometers. Such a laser may be operated in so-called burst mode. This means that instead of individual pulses, a train of a plurality of pulses in very close succession is emitted. The pulse repetition rate of a laser in burst mode is given by the time between the pulse trains. The burst frequency is given by the time between the individual pulses within a pulse train.

The laser source produces, for example, a raw beam with a (1/e²) diameter of 12 mm, and a biconvex lens with a focal length of 16 mm may be used as optics. Suitable beam shaping optics, for example a Galilean telescope, may optionally be used for producing the raw beam.

The laser source operates, in particular, with a pulse repetition rate that between 1 kHz and 1000 kHz, preferably between 10 kHz and 400 kHz, particularly preferably between 30 kHz and 200 kHz.

The pulse repetition rate and/or the forward speed may in this case be selected so that the desired spacing of neighboring modifications is achieved. In particular, the forward speed may be varied in order to alter the spacings between neighboring modifications, and therefore the breaking force.

The suitable pulse duration of a laser pulse lies in a range of less than 100 picoseconds, preferably less than 20 picoseconds.

The typical power of the laser source in this case particularly favorably lies in a range of from 20 to 300 watts. In order to achieve the filamentary modifications, a pulse energy in the burst of more than 400 microjoules is preferably used. A total burst energy of more than 500 microjoules is furthermore advantageous. The burst energy in this case corresponds to the sum of the energy of all pulses in the pulse train.

The pulse duration is substantially independent of whether a laser is operated in single-pulse operation or in burst mode. The pulses within a burst typically have a similar pulse length as a pulse in single-pulse operation. The burst frequency may lie in the interval of from 15 MHz to 90 MHz, preferably in the interval of from 20 MHz to 85 MHz, and is for example 50 MHz, and the number of pulses in the burst may be between 1 and 10 pulses, for example 6 pulses.

Because of the very high burst frequency, all pulses of a pulse train strike substantially the same position of the substrate and together generate the modifications there. The number of laser pulses for respectively producing a modification is in this case selected in particular from the interval of from 1 to 20, preferably from the interval of 1 to 10, particularly preferably from the interval of 2 to 8.

The spacing between neighboring modifications may in particular lie in the interval of from 1 μm to 20 μm, particularly in the interval of 2 μm to 10 μm.

The diameter of the modifications may for example lie in the interval of 0.5 μm to 5 μm, in particular 0.8 μm to 2 μm, and particularly in the interval of 1 μm to 1.5 μm.

The modifications may be arranged at different locations in the flat glass, depending on the way in which the focus of the laser beam is positioned relative to the side faces of the flat glass. For example, they may extend from the surface of the side face facing toward the laser into the volume of the flat glass. They may likewise extend from the surface of the side face facing away from the laser into the volume of the flat glass. They may furthermore extend from the surface of the side face facing away from the laser through the entire thickness of the flat glass as far as the opposite side face. They may likewise extend only in the volume of the flat glass, without contact with one of the side faces. In this way, it is possible in a particularly simple way to produce predetermined breaking locations on both side faces of the flat glass with a single laser, merely by varying the focal positioning.

The person skilled in the art will adjust, or vary, these parameters so that he achieves the desired breaking force behavior of the predetermined breaking locations.

### LIST OF REFERENCE NUMERALS

1 flat glass
3 support
5 pin
7 lower side
9 upper side

What is claimed is:

1. A flat glass comprising:
a first side face;
an opposite, second side face;
at least one edge face;
a linear predetermined breaking location on the first or second side face; and
two mutually separated points, at least one of the two mutually separated points lies on the linear predetermined breaking location, the two mutually separated points each being configured as a point of attack for a force for breaking the flat glass, wherein the two mutually separated points have breaking forces required to break the flat glass that differ from one another in magnitude and/or direction.

2. The flat glass of claim 1, wherein both of the two mutually separated points lie on the linear predetermined breaking location, and wherein the breaking forces differ from one another in magnitude.

3. The flat glass of claim 1, further comprising a second linear predetermined breaking location.

4. The flat glass of claim 3, further comprising two further mutually separated points, the two further mutually separated points both lying on the second linear predetermined breaking location and each are configured as another point of attack for a force for breaking the flat glass, wherein the two further mutually separated points have breaking forces required to break the flat glass that differ from one another in magnitude.

5. The flat glass of claim 3, wherein at least one of the two mutually separated points lies on the second linear predetermined breaking location.

6. The flat glass of claim 3, wherein the linear predetermined breaking location is arranged on the first side face and the second linear predetermined breaking location is arranged on the second side face.

7. The flat glass of claim 1, wherein the magnitude of the breaking forces decrease continuously along the linear predetermined breaking location.

8. The flat glass of claim 1, wherein the magnitude of the breaking forces differ by at least 10% for a spacing between the two mutually separated points of at least 5 mm.

9. The flat glass of claim 1, wherein the magnitude of the breaking forces differ by at least 30% for a spacing between the two mutually separated points of at least 5 mm.

10. The flat glass of claim 1, further comprising a coating on the first side face and/or the second side face, wherein the coating comprises a material selected from a group consisting of epoxysilane, aminosilane, aldehydesilane, a polymer having a reactive N-hydroxysuccinimide terminal group, indium tin oxide, chromium, and any combinations thereof.

11. The flat glass of claim 1, wherein the linear predetermined breaking location is formed by a locally reduced thickness of the flat glass.

12. The flat glass of claim 1, wherein the linear predetermined breaking location comprises a trench indentation in the first side face and/or the second side face.

13. The flat glass of claim 1, wherein the linear predetermined breaking location comprises a crack along the first side face and/or the second side face.

14. The flat glass of claim 1, wherein the linear predetermined breaking location comprises a ultrashort-pulse laser microstructure of locally modified filamentations in the first side face and/or the second side face.

15. The flat glass of claim 1, wherein the linear predetermined breaking location comprises a modification of a microstructure of the glass.

16. The flat glass of claim 15, wherein the modification comprises a sequence of spatially restricted, nonoverlapping modifications of the microstructure, wherein the sequence of spatially restricted, nonoverlapping modifications at the two mutually separated points comprises a spacing and/or a volume that differ from one another.

17. The flat glass of claim 15, wherein the sequence of spatially restricted, nonoverlapping modifications comprise a spacing along the predetermined breaking location that increases or decreases continuously.

18. The flat glass of claim 15, wherein the sequence of spatially restricted, nonoverlapping modifications comprise a spacing along the predetermined breaking location that increases or decreases linearly.

19. The flat glass of claim 1, further comprising a thickness of from 0.7 mm to 10 mm.

20. The flat glass of claim 1, wherein the flat glass is configured as a substrate a medical diagnosis device.
